(19) United States
(12) Patent Application Publication
(10) Pub. No.: US 2026/0073162 A1
(43) Pub. Date: Mar. 12, 2026

(54) DEVICE EQUIPPED WITH AI SYSTEM FOR ASSISTING INDIVIDUALS WITH MUTE AND/OR DEAF DISABILITIES TO CONQUER THEIR COMMUNICATION BARRIERS

(71) Applicant: Xiangfei Cheng, Montgomery Village, MD (US)

(72) Inventor: Xiangfei Cheng, Montgomery Village, MD (US)

(21) Appl. No.: 19/264,142

(22) Filed: Jul. 9, 2025

Related U.S. Application Data
(60) Provisional application No. 63/670,801, filed on Jul. 12, 2024.

(51) Int. Cl. G06F 40/58; G06F 3/02; G06V 40/20; G09B 21/00; G09G 3/00; G10L 13/033; G10L 17/02; H02S 10/20; H04R 1/02; H04R 1/10

(52) U.S. Cl. CPC G06F 40/58; G06V 40/28; G09B 21/009; G10L 13/0335; G10L 17/02; H02S 10/20; H04R 1/028; H04R 1/1008; G06F 3/02; G09G 3/001; H04R 2499/15

(57) ABSTRACT

This innovation presents innovative device equipped with AI system configured to assist deaf-mute individuals to conquer their communication barriers with hearing and speaking individuals without human assistance performing sign language. The AI system is developed and integrated to convert spoken language into sign language or text, sign language into synthesized speech, automatically detect a preferred language, distinguish speakers and speaker's language to convert spoken language into sign language or text, and adjust the speech output language accordingly. The device comprises a wearable frame, touch button, AI system, micro video camera, microphone, speaker, transparent display system, rechargeable battery and/or solar panel to supply energy, Wi-Fi system and software interface. This present innovative device equipped with AI system assists mute and/or deaf individuals to conquer their communication barriers through AI-driven converting sign language into synthesized speech and spoken language into sign language or text.

### CROSS-REFERENCE TO RELATED APPLICATIONS

This application claims priority to U.S. Provisional Application No. 63/670,801 filed Jul. 12, 2024, which is incorporated herein by reference.

### STATEMENT REGARDING FEDERALLY SPONSORED RESEARCH OR DEVELOPMENT

Not Applicable

### REFERENCE TO A SEQUENCE LISTING, A LARGE TABLE, OR A COMPUTER PROGRAM LISTING APPENDIX ON READ-ONLY OPTICAL DISC

Not Applicable

### BACKGROUND OF THE INVENTION

According to NIH report, about 2 to 3 out of every 1,000 children in the United States are born with a detectable level of hearing loss in one or both ears (CDC, 1999-2007), approximately 15% of American adults (37.5 million) ages 18 and over report some trouble hearing (Blackwell et al., 2014). Age is the strongest predictor of hearing loss among adults ages 20-69, with the greatest amount of hearing loss in the 60-69 age group (Hoffman et al., 2016). Men are almost twice as likely as women to have hearing loss among adults ages 20-69 (Hoffman et al., 2016). 1 in 8 people in the United States (13%, or 30 million) ages 12 or older has hearing loss in both ears, based on standard hearing examinations (Lin et al., 2011). Among adults ages 20 to 69, approximately 8% have depression (based on the PHQ-9). In comparison, about 18% of adults with moderate or worse hearing loss have depression (Chakrabarty et al., 2024). Among adults above the age of 52 with moderate to severe hearing loss, about 28% experience difficulty with daily activities. In comparison, among people in the same age range without hearing loss, 7.3% experience difficulty with daily activities (Dalton et al., 2003). The World Health Organization stated that approximately 70 million people in the world are deaf-mutes (Babour et al., 2023).

Mute and/or deaf disabilities are hereinafter referred as to deaf-mute individuals. It is unmet need to develop solutions to assist these populations to conquer their communication barriers. The present invention is an innovative device equipped with artificial intelligence (AI) system configured to assist mute and/or deaf individuals to conquer their communication barriers. This innovative device integrates various cutting-edge technologies and an AI system trained to recognize sign language and spoken language for converting sign language into synthesized speech, and spoken language into sign language or text, distinguishing it from traditional devices. In this presentation, synthesized speech refers to artificially generated human-like speech.

In various embodiments, the device may be implemented in multiple wearable form factors. While one embodiment of the device may take the form of a glasses-type frame worn on the user's head, this is not limiting. In other embodiments, the device may be implemented as a headset, visor, headband, helmet-mounted display, or any other wearable platform capable of supporting a transparent or semi-transparent display system and associated components. The transparent display system is positioned to render the sign language or text within the user's forward field of vision when the device is worn. Accordingly, references to glasses-type configurations herein are intended to describe one possible form of the invention, and not to limit its scope.

### BRIEF SUMMARY OF THE INVENTION

The present invention proposes a groundbreaking approach to conquer their communication barriers for individuals with mute and/or deaf disabilities. Key Features of The Invention Include:
a) Real-time Communications: The deaf-mute disability individuals can communicate with individual without auditory or speech disabilities in real time by using this innovative device equipped with AI system without human assistance for performing sign language. In present presentation, an individual without auditory or speech disabilities is hereinafter referred to as a ‘hearing and speaking individual’. The sign language is a visual language used primarily by people who are deaf or hard of hearing, employing hand gestures, facial expressions, head and lip movement, and body language to convey meaning.
b) Unnecessary Training in Sign Language for Hearing and Speaking Individual: hearing and speaking individuals are unnecessary to be trained in sign language for them to communicate with the deaf-mute disability individuals who use this innovative device equipped with AI system. The individuals with mute and/or deaf are needed to be trained in sign language.
c) Able to Watch TV and Listen to Broadcast without Assistance with Sign Language Performer: By using the innovative device equipped with AI system, the deaf-mute disability individuals are able to watch TV and listen to broadcast without assistance of converting spoken language into sign language by sign language performer.
d) Mobile and Portable: This innovative device equipped with AI system is mobile and portable.

### Innovation and Advantages

Compared to existing solutions, this innovative device equipped with AI system offer several distinct advantages, but not limited to:
a) Assist deaf-mute Individuals to Conquer Their Communication Barriers: Assist users to communicate in real time without assistance of translation between spoken language and sign language by sign language performer. In this presentation, spoken language refers to languages used by hearing and speaking individuals for everyday communication.
b) User-Centric Design: Settings ensure optimal comfort and functionality for individual usage.
c) Advanced Technology Integration: Incorporates state-of-the-art technology.

By addressing the limitations of current solutions, this present invention represents a significant leap forward in conquering their communication barriers for mute and/or deaf individuals.

As used herein, the term “AI system” refers to a software-implemented module comprising machine learning algorithms, data processing components, and decision-making logic configured to adapt device behavior based on input data, convert sign language into synthesized speech and spoken language into sign language or text by recognizing sign language and spoken language, and issue commands via software interface accordingly.

### BRIEF DESCRIPTION OF THE SEVERAL VIEWS OF THE DRAWING

FIG. 1. Diagram Illustrating the Mechanism of Action of Device. The device comprises a wearable frame into which AI system, a touch button, micro video camera, microphone, speaker, transparent display system, a rechargeable battery, Wi-Fi system for wireless communication, and a software interface are integrated. Optionally, a solar energy harvesting unit is connected to the wearable frame to provide power to the device. One or more of the micro video camera, microphone, AI system, speaker, software interface, Wi-Fi system and touch button are optionally integrated into the solar energy harvesting unit rather than the wearable frame. When a deaf-mute individual wears this device to communicates with hearing and speaking individuals, the sign language, including hand gestures, facial expressions, lip and head movement and body language, performed by deaf-mute individual is captured by micro video camera in device. The AI system in the device converts the sign language into selected synthesized speech. The device uses a speaker to output the synthesized speech, allowing the hearing and speaking individuals to hear it. When hearing and speaking individual speaks, the microphone in device captures the spoken language while the AI system converts spoken language into sign language or text. The sign language or text is displayed in transparent display system in the device, which allows the deaf-mute individual to view it. The software interface is configured to communicate with AI system, micro video camera, microphone, speaker, transparent display system, Wi-Fi system and touch button, and to deliver context-aware prompts or commands in the device. The touch button is configured to allow the user to provide manual input or commands. The solar energy harvesting unit can be positioned anywhere to receive sunlight and connect to the wearable frame on the user's body. In this innovation, a wearable glasses-type device serves as an example embodiment, with the solar energy harvesting unit positioned on top of the head.

### DETAILED DESCRIPTION OF THE INVENTION

### Strategy:

a) Convert Spoken Language into Sign Language or Text:

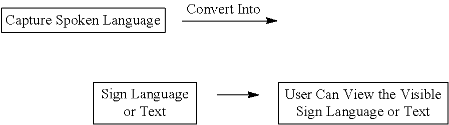

b) Convert Sign Language into Synthesized Speech:

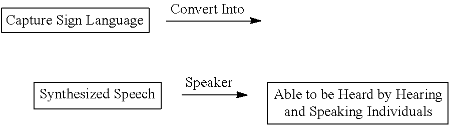

### Methods

The AI system is developed as follows:
a) Robust Collection of Data: Robust collection of data including diverse spoken languages and sign languages from different countries, comprising hand gestures, facial expressions, lip and head movement and body language from reliable sources;
b) Data Analysis;
c) Sophisticated Algorithms;
d) Applications of Machine Learning technologies;
e) Generating an AI system trained to convert spoken language into sign language or text, and sign language into synthesized speech, automatically detect a preferred language, distinguish speaker's language by analyzing spoken language, identify speakers based on voice type and speaking style, adapt device behavior based on input data and issue commands via software interface accordingly.

The device for communication between deaf-mute disabilities individuals and hearing and speaking individual is configured as follows:
a) The device comprises a wearable frame into which AI system, a touch button, micro video camera, microphone, speaker, a transparent display system, a rechargeable battery, Wi-Fi system for wireless communication, and a software interface are integrated. Optionally, a solar energy harvesting unit is connected to the wearable frame to provide power to the device. One or more of the micro video camera, microphone, speaker, AI system, software interface, Wi-Fi system and touch button are optionally integrated into the solar energy harvesting unit rather than the wearable frame. The wearable glasses-type frame incorporates a transparent display element configured to render sign language or textual information within the user's forward field of vision. This transparent display system allows the user to simultaneously perceive both the displayed content and the surrounding real-world environment, thereby supporting continuous situational awareness during use.
b) In various embodiments, the transparent display element may utilize any suitable optical or electronic means to present sign language, virtual text, images, symbols, or guidance information either on, within, or through the lens material. Suitable technologies may include, but are not limited to, embedded light-emitting layers (e.g., transparent OLED or micro-LED panels), projection onto treated or coated surfaces of the lens, optical combiners, beam splitters, or other see-through visualization methods. In some configurations, a micro-display coupled with projection optics may be used to direct image content into a transparent optical waveguide or reflective element embedded in or adjacent to the lens.
c) The transparent display system design is intended to be adaptable to multiple hardware platforms, allowing flexibility in implementation while maintaining the core functionality of presenting sign language or context-relevant textual information in a hands-free, real-time manner. The display may be monocular or binocular, fixed or dynamically adjustable, and may be controlled in response to user input, AI-driven decision-making, or environmental cues.
d) Video camera captures sign language performed by deaf-mute disabilities individual in real time. The AI system convert sign language into synthesized speech so that the input can be played as audio output through the speaker in real time;
e) The microphone captures sound in real time. The AI system converts the spoken language into sign language or text while sign language or text is appeared in the transparent display system;
f) Software interface is configured to communicate with AI system, micro video camera, microphone, speaker, transparent display system, Wi-Fi system and touch button, and to deliver context-aware prompts or commands.

### Scientific and Functional Rationale of the Present Invention

Sign language involves the usage of the upper part of the body, such as hand gestures (Gupta and Rajan, 2020), facial expression (Chowdhry et al., 2013), lip-reading (Cheok et al., 2019), head nod-ding and body postures to disseminate information (Butt et al., 2019; Rastgoo et al., 2021b; Lee et al., 2021). The key techniques for sign language recognition are vision-based and wearable sensing modalities such as sensory gloves. Sign language recognition systems based on these approaches have been proposed by several researchers (Ionescu et al., 2005; Yu et al., 2010; Li et al., 2015; Sonkusare et al., 2015; Bobic et al., 2016; Islam et al., 2017; Islam et al., 2017; Saha et al., 2018; Rastgoo et al., 2021a; Xu et al., 2021).

Prior AI systems were trained to recognize isolated motion or limited combinations thereof, such as hand gestures, facial expression, lip-reading and head moving, respectively. Sign language is expressed not only by isolated hand gestures, facial expression, lip and head movements, but also through coordinated full-body motions. The AI system of this present invention is trained to recognize all of these movements within a unified model and is capable of converting sign language into synthesized speech in real time based on all of these movements and coordinated whole-body motions, and to recognize spoken language while converting the spoken language into sign language or text. Sign languages are not universal like spoken languages, and it varies across countries due to different geographical locations, nationality, social boundaries and vocabularies (Lemaster and Monaghan, 2007). There are various sign languages all over the world. The most countries that share a spoken language do not share the same sign language. In present innovation, the AI system is trained to automatically detect a preferred language, distinguish speaker's language by analyzing spoken language, and identify speakers based on voice type and speaking style. This innovative device comprises a touch button configured to allow the user to select a preferred sign language, text and spoken language which are converted into.

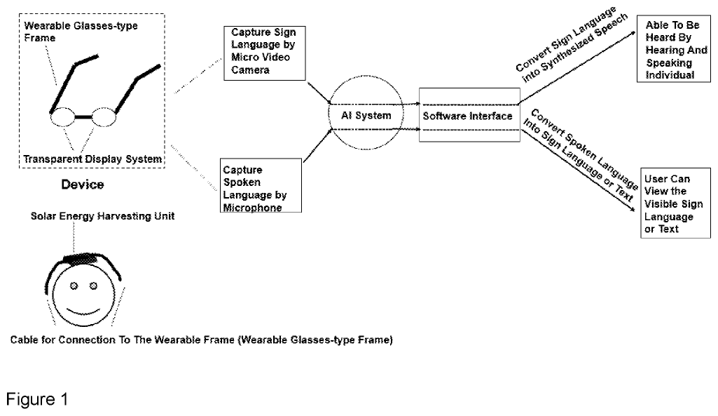

In this present innovation, the AI system which converts spoken language into sign language or text, and sign language into synthesized speech is developed by robust collection of data including spoken language and sign language comprising hand gestures, facial expression, lip and head movement and body language from reliable sources, followed by data analysis, implementation of sophisticated algorithms, and application of machine learning techniques. The scientific rational of this innovative device (FIG. 1) is when deaf-mute individual who wears this device communicates with hearing and speaking individual the sign language performed by deaf-mute individual is captured by micro video camera in the device. The AI system converts the sign language into synthesized speech. The device uses a speaker to output the synthesized speech, allowing the hearing and speaking individual to hear it. When hearing and speaking individual speaks, the microphone in the device captures the spoken language while the AI system converts spoken language into sign language or text. The sign language or text is displayed in transparent display system in the device, which allows the deaf-mute individual to view it. Additionally, the AI system in the device is configured to dynamically switch between two or more languages based on user input or location data, automatically detect a preferred language, distinguish speaker's language by analyzing spoken language, and identify speakers based on voice type and speaking style to convert the speaker's spoken language into sign language or text, and adjust the speech output language accordingly. The software interface is configured to communicate with AI system, micro video camera, microphone, speaker, transparent display system, Wi-Fi system and touch button, to deliver context-aware prompts or commands. The touch button allows a user to adjust one or more parameters selected from the group consisting of volume, speed, pitch, sign language, spoken language, text and voice type.

### DISCUSSION

This innovative device equipped with AI system represents a significant advancement, particularly for individuals with disabilities affecting communications functions. The primary goal of this innovation is configured to assist deaf-mutes to conquer their communication barriers, thereby enhancing the quality of their life. Several key aspects highlight the importance and potential impact of this invention.

### Technological Integration

This innovative device incorporates AI system to convert sign language into synthesized speech, and spoken language into sign language or text by recognizing both sign language and spoken language for assisting the deaf-mute individuals to conquer communication barriers. Real-time mechanisms assist them to communicate in real time. This level of technological integration sets the systems apart from traditional solutions.

### Mobile and Portable

One of the most critical features of this innovative device equipped with AI system is mobile and portable. It does not only assist deaf-mute individuals to conquer communication barriers with hearing and speaking individuals but also assist them to watch TV and listen to broadcast without human assistance performing sign language.

### Impact on Independence and Quality of Life

By conquering deaf-mute individuals' communication barriers, this innovative device equipped with AI system significantly impact the user's independence. Being able to communicate independently can lead to improve mental health, greater social interaction, and increase participation in various activities. This innovative device equipped with AI system can be transformative, allowing users to engage more fully with their surroundings and reducing reliance on caregivers or other assistive devices.

### Addressing Limitations of Existing Solutions

Current assistances, such as using hearing aids and sign language performer, offer valuable support but often come with limitations. However, broadcast is unable to offer sign language and most TV programs do not offer assistance with sign language. Most of hearing and speaking individuals have no experience and knowledge in sign language. By addressing these limitations, this innovative device equipped with AI system offer a solution to conquer deaf-mute individuals' communication barriers and enhance quality of their life. This device enables communication in diverse languages.

Babour et al. (2023) reported an information technology intervention, intelligent gloves (IG), a prototype of a two-way communication glove. In their study, IG was developed to facilitate communication between deaf-mutes and hearing and speaking individual (non-deaf-mute). IG consists of a pair of gloves, flex sensors, an Arduino nano, a screen with a built-in microphone, a speaker, and an SD card module. To facilitate communication from the deaf-mutes to the non-deaf-mutes, the flex sensors sense the hand gestures and connected wires, and then transmit the hand movement signals to the Arduino nano where they are translated into words and sentences. The output is displayed on a small screen attached to the gloves, and it is also issued as voice from the speakers attached to the gloves. For communication from the non-deaf-mutes to the deaf-mute, the built-in micro phone in the screen senses the voice, which is then transmitted to the Arduino nano to translate it to sentences and sign language, which are displayed on the screen using a 3D avatar. A unit testing of IG has shown that it performed as expected without errors. In addition, IG was tested on ten participants, and it has been shown to be both usable and accepted by the target users. However, in my present invention, the AI system built into device is trained to recognize sign language not only based on hand gestures, but also based on full-body movements to capture sign language more accurately.

### Rationale of not Obvious and Unexpected Advantages of the Invention

The present invention integrates an AI system with multiple components into a unified platform for assisting deaf-mute individuals to conquer their communication barriers. The use of this multi-functional design to achieve the described effects would not have been obvious to a person having ordinary skill in the art, as the prior art neither teaches nor suggests combining these components in the manner disclosed, nor provides any motivation to do so absent the inventive insight introduced by the present invention. Integration of the multiple components with the AI system provides unexpected advantages over conventional systems.

Notably, although individual components or mechanisms described herein may be supported by prior literature, my present invention is based on a novel and non-obvious integration of these components in a specific and synergistic manner that yields functional advantages not suggested or taught in the prior art. The invention described herein is not a mere aggregation of known components, but rather a purposeful integration of structural and functional elements configured to achieve a synergistic effect and enable precise alignment of converting sing language into synthesized speech and spoken language into sign language or text.

### IN CONCLUSION

In summary, this innovative device equipped with AI system represents a substantial leap forward in conquering deaf-mute individuals' communication barriers and enhancing quality of their life. Its advanced features, mobile, supporting multiple language, portable and user-centric design address the shortcomings of current solutions and offer a communication independence.

1. A device equipped with AI system for assisting mute and/or deaf individuals (deaf-mute individuals) to conquer their communication barriers, comprising:
1) a wearable frame selected from the group consisting of a glasses-type frame, visor, headset, helmet, headband, or other head-mounted apparatus;
2) a micro video camera integrated into the wearable frame and configured to capture sign language;
3) a microphone integrated into the wearable frame and configured to capture sounds;
4) a speaker integrated into the wearable frame and configured to output the synthesized speech;
5) an artificial intelligence (AI) system integrated into the wearable frame and configured to convert sign language into synthesized speech, and spoken language into sign language or text in real time;
6) a software interface integrated into the wearable frame and configured to communicate with AI system, micro video camera, microphone, speaker, transparent display system, Wi-Fi system and touch button, and to deliver context-aware prompts or commands;
7) Wi-Fi system integrated into the wearable frame for wireless communication;
8) a transparent display system integrated into the wearable frame and configured to display sign language or text, wherein the transparent display system is positioned to project or render sign language or text within the user's forward field of vision when the device is worn;
9) a touch button integrated into the wearable frame and configured to allow the user to provide manual input or commands;
10) a power supply system comprising a rechargeable battery integrated into the wearable frame and, optionally, a solar energy harvesting unit connected to the wearable frame; and
11) wherein one or more of the micro video camera, microphone, speaker, AI system, software interface, Wi-Fi system and touch button are optionally integrated into the solar energy harvesting unit rather than the wearable frame.

2. The device of claim 1, wherein AI system is configured to dynamically switch between two or more languages based on user input or location data.

3. The device of claim 1, wherein the AI system is configured to automatically detect a preferred language and adjust the speech output language accordingly.

4. The device of claim 1, wherein the AI system is configured to automatically identify speakers based on voice type and speaking style to convert the speaker's spoken language into sign language or text.

5. The device of claim 1, wherein the AI system is configured to distinguish speaker's language by analyzing spoken language while converting the spoken language into sign language or text.

6. The device of claim 1, wherein the device is configured to assist mute and/or deaf Individuals to communicate with hearing and speaking individual by converting sign language into synthesized speech, and spoken language into sign language or text without sign language performer's assistance.

7. The device of claim 1, wherein the device is configured to assist hearing and speaking individuals without knowing sign language to communicate with mute and/or deaf individuals who wear this device.

8. The device of claim 1, wherein the device is configured to assist mute and/or deaf individuals to watch TV program and listen to broadcast without human assistance for sign language performing.

9. The device of claim 1, wherein the AI system, trained to convert spoken language into sign language or text, and sign language into synthesized speech, is developed through robust data collection, including spoken language and sign language, comprising hand gestures, facial expressions, lip and head movement and body language, from reliable sources, followed by data analysis, implementation of sophisticated algorithms, and application of machine learning techniques.

10. The device of claim 1, wherein the touch button is configured to allow a user to adjust one or more parameters selected from the group consisting of speech speed and volume, pitch, sign language, spoken language, text and voice type.

11. The device of claim 1, wherein the device comprises one or more modifications selected from the group consisting of structural variations, material substitutions, hardware or software adaptations, or reconfigurations of component connections, sign language change, spoken language change, the modifications maintaining the functional principles and operational mode of the device defined in claim 1.
